(19) United States
(12) Patent Application Publication
(10) Pub. No.: US 2009/0180544 A1
(43) Pub. Date: Jul. 16, 2009

(54) DECODING STAGE MOTION DETECTION FOR VIDEO SIGNAL DEINTERLACING

(75) Inventors: Uri Nix, Haifa (IL); Liron Ain-Kedem, Kiryat Tivon (IL)

Correspondence Address: Lowrie, Lando & Anastasi, LLP;Z2002, One Main Street, Suite 1100, Cambridge, MA, 02142, US

(73) Assignee: ZORAN CORPORATION, Sunnyvale, CA (US)

(21) Appl. No.: 12/350,672

(22) Filed: Jan. 8, 2009

Related U.S. Application Data
(60) Provisional application No. 61/020,649, filed on Jan. 11, 2008.
(60) Provisional application No. 61/054,879, filed on May 21, 2008.

(51) Int. Cl. H04N 7/26

(52) U.S. Cl. 375/240.16; 375/240.24; 375/E07.123

(57) ABSTRACT

Systems and methods directed to processing a video signal, either interlaced or progressive, are provided. A plurality of samples of a reconstructed macroblock of the video signal are evaluated to generate data associated with at least one of the plurality of samples. The data and the reconstructed macroblock can be provided from memory to a deinterlacer unit, and the method can control the deinterlacer unit to deinterlace the reconstructed macroblock based at least in part on the data. Artifacts of the video signal can be identified and removed based on the stored sample data associated with the samples.

### CROSS REFERENCE TO RELATED APPLICATIONS

This application claims priority under 35 U.S.C. 119(e) to U.S. Provisional Application Ser. No. 61/020,649 entitled “Using Decoding Stage Motion Detection for de-interlacing,” filed Jan. 11, 2008, and to U.S. Provisional Application Ser. No. 61/054,879 entitled “Using Decoding Stage Motion Detection for De-Interlacing,” filed May 21, 2008, both of which are incorporated herein by reference in their entirety.

### BACKGROUND OF THE INVENTION

1. Field of the Invention

Aspects of the present invention are directed to processing of a video signal, and more particularly to a system and method for deinterlacing a digital video signal.

2. Background of the Invention

Video signals include a series of images, or frames, played in succession. A video signal includes a series of frames each divided into two fields. One type of video signal transmits one field that contains odd lines of pixels in a frame, and then another field that contains even lines of pixels in a frame. Dividing each frame into a set of odd fields and a set of even fields reduces the amount of bandwidth necessary to transmit a video signal. Interlaced video signals are generated and transmitted in a compressed and encoded form over a communication channel.

Interlaced video signals are not well suited for modern computer monitors or televisions, such as those with plasma, liquid crystal, or other displays that support high definition formats. For optimal performance these devices and others generally require a non-interlaced progressively scanned signal. Another type of video signal transmission is progressive. In progressive transmission, also known as non-interlaced scanning, all lines of each frame are drawn in sequence. Typically the progressive video signal passes a frame-rate conversion that introduces artifacts visible in the progressive output.

A video deinterlacing process receives the encoded interlaced video signal or the progressive video signal, decodes it, and provides the decoded signal to a deinterlacer. The deinterlacer converts the decoded video signal into a non-interlaced form to improve image quality and to make the video signal compatible with a device designed to display progressively scanned signals. Deinterlacing produces higher resolution frames by recombining the odd and even fields into a frame for simultaneous display.

Deinterlacing, however, is not without its drawbacks. Odd and even fields of interlaced video signals are successively scanned, and as a result an object that is in motion may be in one position during scanning of one field, and may be in a different position during subsequent scanning of another field. Motion of objects that takes place in the time period between the odd and even field scans of an interlaced signal results in visually perceptible and undesirable artifacts. These artifacts are encoded into the interlaced video signal, where they remain as the interlaced video signal is transmitted over a communication channel and decoded. Deinterlacing of the decoded interlaced video signal overlays the odd and even fields into a frame. Artifacts may be present in progressive video signal regardless and therefore the deinterlacer is also responsible to correct such artifacts. Motion that is present between the odd an even fields of a frame manifests itself as unwanted artifacts that degrade the image of the deinterlaced, or progressive, video signal. The various known deinterlacing schemes are imperfect, as visually perceptible distortions appear in a display of the deinterlaced video signal, reducing its quality on both standard and high definition displays.

### SUMMARY OF THE INVENTION

The aspects and embodiments of the present invention are directed to systems and methods for processing a video signal for the purpose of improved display of the deinterlaced frames, regardless of the input being an interlaced video signal or a progressive video signal. To increase efficiency and enhance video quality, sample data can be detected on a sample by sample basis by evaluating a decoded video signal. Stored data associated with the samples of the video signal, and the video signal itself can both be provided to a deinterlacer unit. The deinterlacer unit can receive the decoded video signal and the data, and can implement an optimal deinterlacing scheme based at least in part on the previously stored data that is provided to the deinterlacer with the decoded video signal. This improves the displayed quality of video signals.

At least one aspect is directed to a method for processing a video signal, either interlaced or progressive. The method evaluates a plurality of samples of a reconstructed macroblock of the video signal to generate and store data associated with at least one of the plurality of samples. The method provides the stored data and the reconstructed macroblock to a deinterlacer unit, and can control the deinterlacer unit to deinterlace the reconstructed macroblock based at least in part on the data.

At least one other aspect is directed to a system for processing a video signal, either interlaced or progressive. The system includes a detector unit that operates on a reconstructed macroblock of the video signal. The detector unit can evaluate a plurality of samples of the reconstructed macroblock to generate and store data associated with at least one of the plurality of samples. The system can include a controller that provides the data and the reconstructed macroblock to a deinterlacer unit and the deinterlacer unit can deinterlace the interlaced video signal based at least in part on the stored data.

At least one other aspect is directed to a computer readable medium having stored thereon sequences of instructions. The instructions include instructions that can cause a processor to receive a decoded video signal, either interlaced or progressive, that includes a reconstructed macroblock. The instructions can cause the processor to evaluate a plurality of samples of the reconstructed macroblock to generate and store data associated with at least one of the plurality of samples. The stored data can be associated with motion. The instructions can cause the processor to provide the stored data and the reconstructed macroblock to a deinterlacer unit, and can control the deinterlacer unit to deinterlace the reconstructed macroblock based at least in part on the stored data.

At least one other aspect is directed to a system for processing a video signal, either interlaced or progressive, corresponding to an image. The system includes a detector unit that receives a reconstructed macroblock of the video signal, and means for evaluating a plurality of samples of the reconstructed macroblock to generate and store data associated with at least one of the plurality of samples. The system can also include a controller configured to provide the stored data and the reconstructed macroblock to a deinterlacer unit, where the deinterlacer unit is configured to deinterlace the interlaced video signal based at least in part on the stored data.

In various embodiments, an encoded bitstream of the video signal, either interlaced or progressive, can be evaluated to identify a motion vector value associated with a macroblock of the video signal. The motion vector value can be provided to the deinterlacer unit, and the deinterlacer unit can deinterlace the video signal based at least in part on the motion vector value. Any of the stored data, the motion vector value, and the reconstructed macroblock can be stored in a memory unit, and the video signal can be provided to the deinterlacer unit. The reconstructed macroblock can be generated by decoding an encoded bitstream of the video signal. Cadence of the interlaced video signal can be detected, and information related to the cadence of the interlaced video signal can be provided to the deinterlacer unit. A sample associated with an edge of an image of the video signal can be detected, and data provided to the deinterlacer unit can include information identifying the sample as being associated with an edge. The sample can be evaluated to detect a sample associated with motion, and information identifying a pixel as being associated with motion can be provided with the reconstructed macroblock to the deinterlacer unit. The deinterlacer unit can be controlled to remove at least one artifact from the video signal during a deinterlacing operation so that it does not appear in a progressive video output signal.

Other aspects, embodiments, and advantages of these exemplary aspects and embodiments will become apparent from the following detailed description, taken in conjunction with the accompanying drawings, illustrating the principles of the invention by way of example only. It is to be understood that the foregoing information and the following detailed description include illustrative examples of various aspects and embodiments, and are intended to provide an overview or framework for understanding the nature and character of the claimed aspects and embodiments. The drawings, together with the remainder of the specification, serve to explain principles and operations of the described and claimed aspects and embodiments.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. The foregoing and other objects, features, and advantages of the systems and methods disclosed herein will be more fully understood from the following description of various embodiments, when read together with the accompanying drawings, in which:

FIG. 1 is a block diagram depicting a system for processing a video signal in accordance with an embodiment of the invention;

FIG. 2 is a diagram depicting frames of interlaced and progressive video signals in accordance with an embodiment of the invention; and

FIG. 3 is a flowchart depicting a method for processing a video signal in accordance with an embodiment of the invention.

### DETAILED DESCRIPTION

The systems and methods described herein are not limited in their application to the details of construction and the arrangement of components set forth in the description or illustrated in the drawings. The invention is capable of other embodiments and of being practiced or of being carried out in various ways. Also, the phraseology and terminology used herein is for the purpose of description and should not be regarded as limiting. The use of “including” “comprising” “having” “containing” “involving” and variations thereof herein, is meant to encompass the items listed thereafter and equivalents thereof as well as additional items.

As shown in the drawings for the purposes of illustration, the invention may be embodied in systems and methods for processing a video signal, either interlaced or progressive. For example, macroblocks of an interlaced video signal can be reconstructed when an encoded video signal is decoded. At least one sample of one or more reconstructed macroblocks can be evaluated to generate data related to that sample, and the sample can be reconstructed into a pixel having luminance and chrominance (e.g., YUV) components. The data can relate to, for example, motion, cadence, or edges in the image associated with at least one sample of a reconstructed macroblock. This data, which can be generated on a sample by sample basis, can be provided with the reconstructed macroblocks of the decoded video signal to a deinterlacer for further processing. For example, data associated with the samples can be generated and stored in memory, and the stored data can be used at the appropriate time by the deinterlacer for efficient and effective video signal reconstruction.

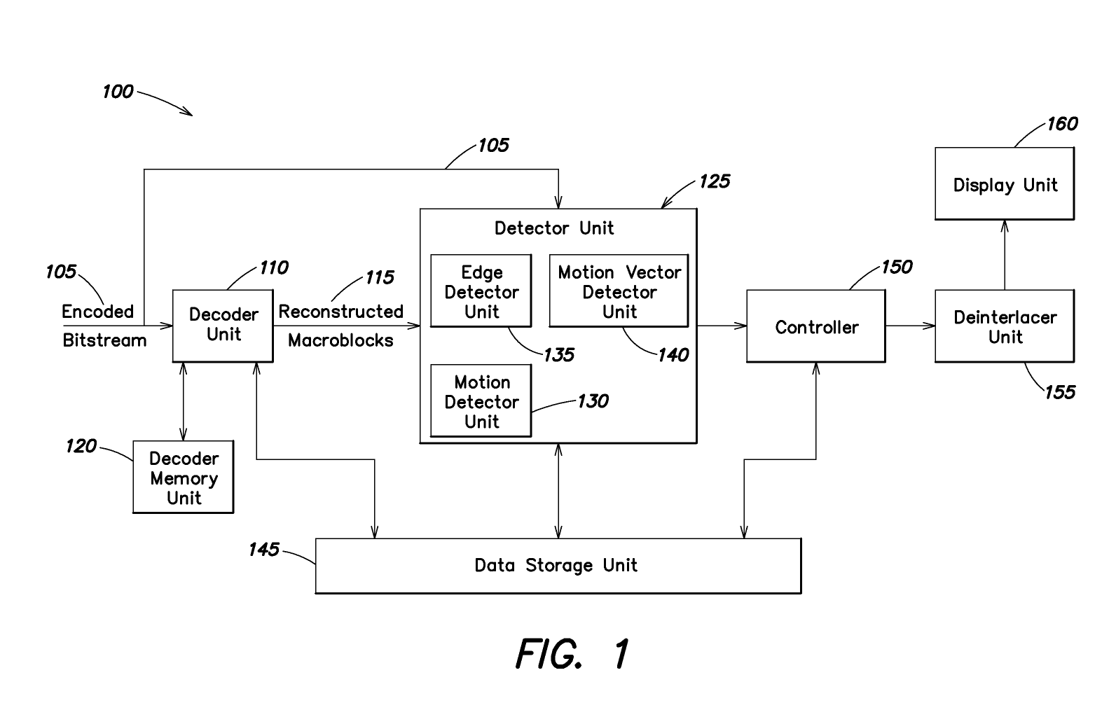

FIG. 1 is a block diagram depicting a system 100 for processing a video signal in accordance with an embodiment of the invention. System 100 includes at least one encoded bitstream 105 of a video signal, either interlaced or progressive. Generally, video signals can be compressed and encoded into encoded bitstream 105.

In one embodiment, encoded bitstream 105 includes an encoded sequence of a plurality of frames of a video signal. Examples of these frames include intra-coded frames, predictive coded frames, and bidirectional predictive coded frames. The frames can be divided into a series of quadrilateral segments, referred to as macroblocks, where each macroblock may contain at least one pixel, or samples thereof, ordered by row and column. In one embodiment, each macroblock includes a four pixel by four pixel block of 16 pixels, although encoded bitstream 105 may include other pixel, or sample configurations and block sizes.

To generate encoded bitstream 105, a video signal can be transformed into a matrix of coefficients. These coefficients are then quantized into discrete values, and each quantized coefficient matrix can be compressed to further reduce the matrix to a smaller array of discrete numbers. A Fourier related transform such as a discrete cosine transform (DCT) is an example of a transform that can be applied to each macroblock to facilitate this compression. In one embodiment, encoded bitstream 105 can be generated using video compression and coding standards such as any of MPEG, MPEG2, H.261, H.263, and H.264, for example.

Encoded bitstream 105 can then be provided, for example through a communication channel, to at least one decoder unit 110. Decoder unit 110 may include a circuit or logic device such as a microprocessor chip, or a multiple-input, multiple-output logic circuit that receives compressed encoded bitstream 105 and generates a series of reconstructed macroblocks 115. The reconstructed macroblocks 115 can be stored at least in data storage unit 145. In one embodiment the decoder unit 110 may have a dedicated memory 120 for storing the reconstructed macroblocks 115. In one embodiment, decoder unit 110 decodes encoded bitstream 105 to reconstruct the video signal. For example, decoder unit 110 may decompress encoded bitstream 105 to generate decoded portions of the video signal that include one or more decoded reconstructed macroblocks 115 from encoded bitstream 105. In one embodiment, reconstructed macroblocks 115 are reconstituted from encoded bitstream 105 and may correspond to macroblocks present in a video signal as it was created prior to encoding. For example, a decoded video signal may include a plurality of reconstructed macroblocks 115, and reconstructed macroblocks 115 may include a quadrilateral segment of pixels, or samples thereof, such as a four pixel by four pixel block of 16 pixels, although other configurations and numbers of pixels, or samples thereof, may form reconstructed macroblock 115.

Reconstructed macroblocks 115 can be provided to at least one detector unit 125. In various embodiments, detector unit 125 includes least one of motion detector unit 130 and edge detector unit 135, and at least one motion vector detector unit 140. In one embodiment, detector unit 125 evaluates reconstructed macroblocks 115 of a decoded and decompressed video signal. Detector unit 125 may also include a circuit or one or more logic devices. Encoded bitstream 105 may also be provided to detector unit 125. For example, motion vector detector unit 140 of detector unit 125 may evaluate encoded bitstream 105 to determine at least one motion vector associated with a macroblock of encoded bitstream 105. This motion vector generally represents a degree of motion of a complete macroblock of encoded bitstream 105. Continuing with this illustrative embodiment, detector unit 125 can also operate on reconstructed macroblock 115 of the decoded video signal provided by decoder unit 110. At least one of motion detector unit 130 and/or edge detector unit 135 of detector unit 125 may evaluate a plurality of samples of reconstructed macroblock 115 to generate data associated with one or more samples of reconstructed macroblock 115. For example, detector unit 125 may detect individual samples of reconstructed macroblocks 115 that are associated with motion. Data generated by detector unit 125 evaluating reconstructed macroblock 115 can associate at least one sample of reconstructed macroblock 115 with motion, cadence, or an edge of an image represented by a video signal.

In one embodiment, detector unit 125 evaluates reconstructed macroblocks 115 on a sample by sample basis to generate data associated with individual samples of reconstructed macroblock 115. As described herein, references to detector unit 125 evaluating samples of reconstructed macroblocks 115 can include detector unit 125 evaluating any data, values, or coefficients that are associated with any sample of reconstructed macroblock 115. In various embodiments, samples of a video signal or its reconstructed macroblock 115 include a direct or indirect representation of a pixel during processing. For example, samples may include values or components (e.g., luminance or chrominance) associated with pixels of the video signal. The results of the evaluation can include data indicative of a magnitude, nature, or scope of any edge, cadence, or motion associated with samples of reconstructed macroblock 115. In one embodiment, detector unit 125 evaluates reconstructed macroblocks 115 to determine field motion data associated with at least one sample of a reconstructed macroblock 115. Field motion data generally includes data indicative of motion between fields of a frame (e.g., odd and even fields) of a video signal. The evaluation of samples values of reconstructed macroblock 115 samples by detector unit 125 can include an evaluation of luminance, chrominance, or other values of a plurality of samples.

In one embodiment, system 100 does not make use of motion vectors. It should be appreciated, however, that in another embodiment the motion vector can be determined by motion vector detector unit 140 based on an evaluation of encoded bitstream 105. For example, the motion vector may be a vector indicative of motion of a complete macroblock of encoded bitstream 105. This information is supplementary to data generated based on an evaluation of the samples of reconstructed macroblocks 115. For example, detector unit 125 may receive both encoded bitstream 105 and reconstructed macroblocks 115 of a decoded video signal. Decoder unit 125 may then determine, based on an evaluation of encoded bitstream 105 of a video signal, a motion vector associated with a macroblock of encoded bitstream 105. Detector unit 125 may also determine, based on an evaluation of reconstructed macroblock 115 of a decoded video signal, additional data associated with one or more samples of reconstructed macroblock 115. It should be further appreciated that encoded bitstream 105 can be provided as input to decoder unit 110, and that reconstructed macroblocks 115 can be provided as output from decoder unit 110 due, for example, to sample evaluation operations performed on encoded bitstream 105 by decoder unit 110.

In one embodiment, system 100 includes at least one data storage unit 145. Data storage unit 145, which generally includes any memory device, may interface with decoder unit 110, detector unit 125, controller 150, and deinterlacer unit 155. In one embodiment data storage unit 145 may further comprise a memory controller which may be embedded as part of data storage unit 145 or be an external component thereof. Controller 150 may include a logic device, control circuit, or a processor, and may be part of or associated with detector unit 125. For example, a decoded video signal, output by decoder unit 110 and including reconstructed macroblocks 115 can be provided to controller 150. In one embodiment decoder unit 110 may output a decoded video signal including reconstructed macroblocks 110 to controller 150 directly or via at least one intervening element, such as decoder memory unit 120, detector unit 125, or data storage unit 145. Detector unit 125 may provide data associated with at least one sample of reconstructed macroblocks 115 to controller 150 directly or via an intervening element such as data storage unit 145, which may include at least one buffer. In one embodiment detector unit 125 evaluates each sample of at least one reconstructed macroblock 115 to generate the data associated with each sample.

Sample based data generated by detector unit 125 may indicate, for example, that a sample is or is not associated with motion or with an edge of an image represented by a video signal, either interlaced or progressive. For example, edge detector unit 135 can evaluate individual samples of a decoded video signal to generate data indicating if a sample is associated with an edge. This data can be stored in data storage unit 145. In one embodiment, data indicating that a sample is or is not associated with an edge includes one data bit per sample. This data bit can be written to data storage unit 145 where it may then be read by, for example, at least one of controller 150 and deinterlacer unit 155. It should be appreciated that storing one data bit per sample in data storage unit 145 results in a bandwidth savings over alternative signal processing schemes that require the reading and writing of at least one complete field of a video signal frame to memory. In one embodiment, storing one data bit per pixel indicative of a sample being associated with an edge consumes one fourth of the bandwidth required for full field data storage utilized by conventional three field deinterlacing schemes.

In one embodiment, controller 150 provides the data associated with each sample and the reconstructed macroblock data to deinterlacer unit 155. Deinterlacer unit 155, which may include at least one logic device, circuit, or processor, may receive an interlaced video signal as well as associated data and generate a progressive video signal corresponding to the interlaced video signal. For example, an interlaced video signal including reconstructed macroblocks 115 may be provided to deinterlacer unit 155. Data associated with the interlaced video signal may also be provided to deinterlacer unit 155. This data, which may be provided sequentially, concurrently, or independently to deinterlacer unit 155, may, but need not, include motion vectors, where each motion vector is associated with a macroblock as a whole, as well as pixel based data associated with motion of individual pixels of at least one macroblock 115. In one embodiment, deinterlacer unit 155 evaluates all data associated with an interlaced video signal, such as sample based motion data and edge data, as well as additional macroblock based motion vector data, to select an appropriate deinterlacing scheme that can be implemented to generate or remove artifacts from a progressive video signal. In one embodiment, deinterlacer unit 155, in addition to deinterlacing an interlaced video signal, also removes artifacts that can exist in both interlaced and progressive video signals.

In one embodiment, when edge detector unit 135 identifies a sample from a reconstructed macroblock 115 as being associated with an edge, data indicating this association can be provided to deinterlacer unit 155 along with the reconstructed macroblock 115 that includes the sample. In one embodiment, this enables deinterlacer unit 155 to use information from the video signal reconstruction to eliminate artifacts associated with deinterlacing of either interlaced or progressive video signals. This information may be stored in data storage unit 145 for use by deinterlacer 155. In one embodiment, detector unit 125 can evaluate detected edges to determine field motion associated with one or more samples of reconstructed macroblock 115, including samples associated with edges. For example, detector unit 125 can read, from data storage unit 145, current and previous field data from two fields to detect motion. In one embodiment, a single data bit can identify a sample as being associated with motion or an edge. This data bit may be written to data storage unit 145 where it may be read by deinterlacer unit 155 directly or via controller 150. Deinterlacer unit 155 may receive the reconstructed macroblock 115 and the data indicating that a sample of that reconstructed macroblock 115 is associated with an edge. Continuing with this example, deinterlacer unit 155 may, but need not, perform an additional edge detection operation on samples associated with reconstructed macroblock 115. Edge detection can enable deinterlacer circuit 155 to sharpen and otherwise improve the display of a corresponding interlaced or progressive video signal.

Although detector unit 125 can detect motion of individual samples of reconstructed macroblocks 115 at a decoding stage prior to use by deinterlacer unit 155, deinterlacer unit 155 may perform additional pixel and/or sample based motion detection operations that are complimentary to those performed by detector unit 125. For example, detector unit 125 may generate data identifying individual samples of reconstructed macroblocks 115 as being associated with, for example, motion between fields of a frame. This data, and the interlaced video signal that includes the reconstructed macroblocks 115, can both be provided to deinterlacer unit 155. Deinterlacer unit 155 can receive the reconstructed macroblocks 115, as well as the sample based data, and may evaluate that data associated with the samples of reconstructed macroblocks to select a deinterlacing operation that includes further motion or edge detection operations performed by deinterlacer unit 155 on reconstructed macroblocks 115 at a deinterlacing stage of operation. In one embodiment deinterlacer unit 155 further evaluates pixels and/or samples of macroblock 115 to detect motion between fields of a frame, or other motion, cadence, or edge data. In various embodiments, the sample based motion or other information detected by deinterlacer unit 155 may be either the same as or different from motion or other information detected by detector unit 125.

In one embodiment, controller 150 may also evaluate data generated by detector unit 125, (e.g., data associated with individual samples of reconstructed macroblocks 115) to generate and provide a signal to deinterlacer unit 155. For example, the signal provided by controller 150 may instruct deinterlacer 155 to select a particular deinterlacing scheme to generate a progressive video signal corresponding to an interlaced video signal decoded by decoder unit 110. The signal provided by controller 150 may include sample based data generated by detector unit 125 and stored in data storage unit 145.

In one embodiment, deinterlacer unit 155 includes a circuit or logic device that can implement a plurality of pixel and/or sample interpolation, weaving, merging, or other functions responsive at least in part to data generated by detector unit 125 and stored in data storage unit 145, indicative of, for example, pixel motion to generate a video signal. Video signals generated by deinterlacer unit 155 may be displayed on at least one display unit 160. Display unit 160 generally includes any device that can receive a video signal and/or data and provide a representation thereof in human perceptible form. Examples of display devices include screen display devices such as televisions, computer monitors, personal digital assistants, cell phone screens, and projection display devices.

It should be appreciated that detecting data associated with individual samples of reconstructed macroblocks 115, such as data indicating that a sample is associated with motion between two consecutive fields of a frame of a video signal, or data indicating that a sample is associated with an edge of an image represented by a video signal, and providing this information to deinterlacer unit 155 can enable deinterlacer circuit 155 to select a deinterlacing scheme that can remove artifacts from a video signal, either interlaced or progressive, so that they do not appear in a resulting video signal. This results in a video signal that may be displayed by display unit 160 with reduced or eliminated visually perceptible artifacts. In one embodiment, this data may be stored in data storage unit 145 for use by deinterlacer 155, and as such processing by the deinterlacer 155 need not occur in real-time. Deinterlacer unit 155 may receive a decoded video signal including reconstructed macroblocks 115, and sample based motion data indicative of, for example, a sample associated with field motion in a frame of a video signal, either interlaced or progressive. Additionally, in one embodiment, deinterlacer unit 155 can also receive macroblock based motion vectors. Deinterlacer unit 155 can evaluate these inputs to select a deinterlacing scheme to be applied to the video signal.

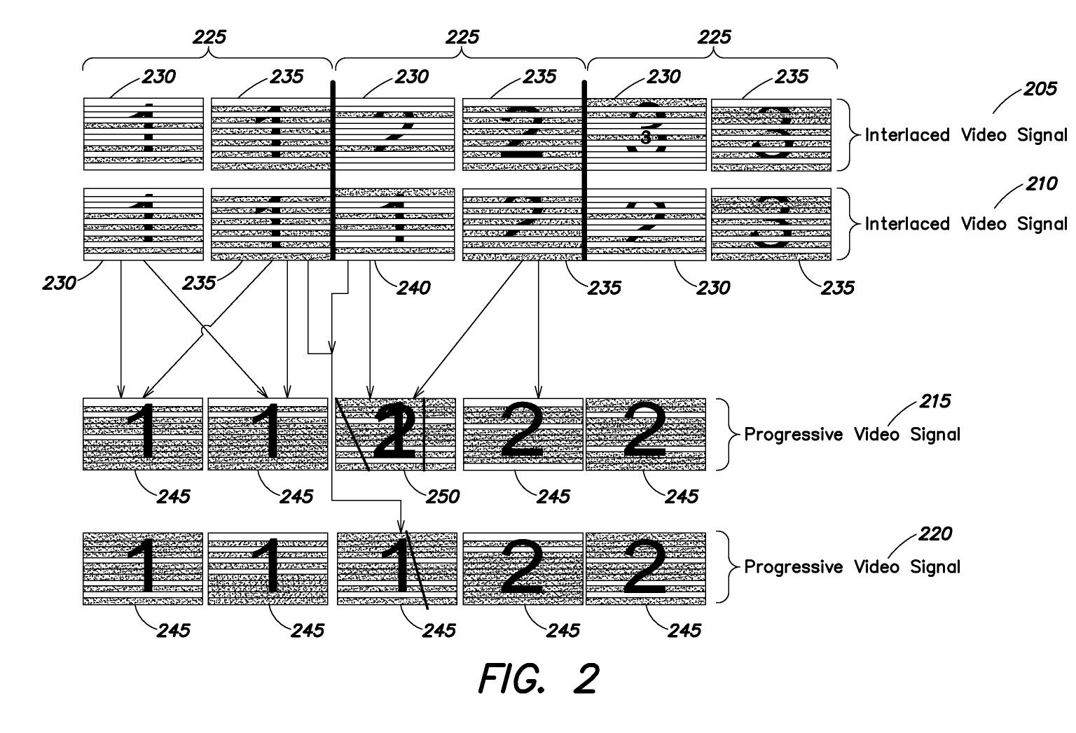

An exemplary embodiment where cadence detection by detector unit 125 can be provided to deinterlacer unit 155 to improve deinterlacing operation is illustrated in FIG. 2, which is a diagram depicting frames of interlaced and progressive video signals in accordance with an embodiment of the invention. FIG. 2 illustrates an example 3-2 pull down operation implemented by detector unit 125. Other cadences may be used when applicable. In FIG. 2, four video signals are provided; interlaced video signal 205, interlaced video signal with added field 210, progressive video signal without cadence detection 215, and progressive video signal with cadence detection 220, the cadence detection performed in accordance with the disclosed invention. Each of interlaced video signals 205 and 210 includes a series of interlaced frames 225, and each interlaced frame 225 includes two consecutive fields, for example odd fields 230 and even fields 235.

However, in one embodiment, to convert a video signal generated at a rate of 24 frames per second into an interlaced video signal with 60 fields per second, at least one added field 240 can be added to an interlaced video signal 210. As illustrated in FIG. 2, added field 240 is the same as odd field 230 of a previous frame, although it is appreciated that other configurations are possible where added field 240 corresponds to any field of any frame of an interlaced video signal. With reference to FIGS. 1 and 2, deinterlacer unit 155 may generate a progressive video signal by combining consecutive fields of an interlaced video signal. As illustrated in FIG. 2, in the absence of cadence detection by, for example detector unit 125 or deinterlacer unit 155, progressive video signal 215 may be generated. Progressive video signal 215 includes a plurality of frames 245, where each frame 245 includes a merger of consecutive fields from frame 225 of interlaced video signal 210. However, due to the change in frame rate resulting from the introduction of added field 240, a merger of consecutive fields of frames 225 generates progressive artifact frame 250 where, as illustrated in FIG. 2, the images from different frames 225 are combined together, causing a visually perceptible overlap of two superimposed separate images.

In one embodiment, a progressive video signal that does not include artifact frame 250 can be generated. For example, motion detector unit 130 may evaluate pixels of reconstructed macroblock 115 to generate data identifying pixels associated with field motion. In this example, controller 150 may evaluate the data to determine cadence of an interlaced video signal. The cadence reflects a rate of frame change of an interlaced video signal. Controller 150 can use this information to identify added fields 240 that have been inserted into an interlaced video signal. Continuing with this illustrative embodiment, controller 150 may provide an indication of added field 240 location to deinterlacer unit 155. Based at least in part on this indication, deinterlacer unit 155 may select a deinterlacing scheme that generates progressive video signal 220, which includes properly combined fields of interlaced video signal 210 (e.g., progressive frames 245) and is free of frame artifact 250.

When, as described in this illustrative embodiment, deinterlacer unit 155 is provided with field motion, cadence, or other data associated with individual pixels of reconstructed macroblocks 115 in addition to an alternate embodiment where, in addition, motion vectors can be associated with macroblocks as a whole, it should be appreciated that the operations and amount of data, (e.g., fields of an interlaced video signal) received or processed by deinterlacer unit 155 can be reduced. For example, decoding stage motion detection performed by detector unit 125 can direct deinterlacer unit 155 to use a particular deinterlacing scheme to generate a progressive video signal. Implementing a targeted deinterlacing scheme can reduce the number of fields (e.g. previous fields or next fields) that deinterlacer unit 155 reads from data storage unit 145 or receives from controller 150. In one embodiment, deinterlacer unit 155 can implement further cadence detection on an interlaced video signal, in addition to cadence detection performed by detector unit 125.

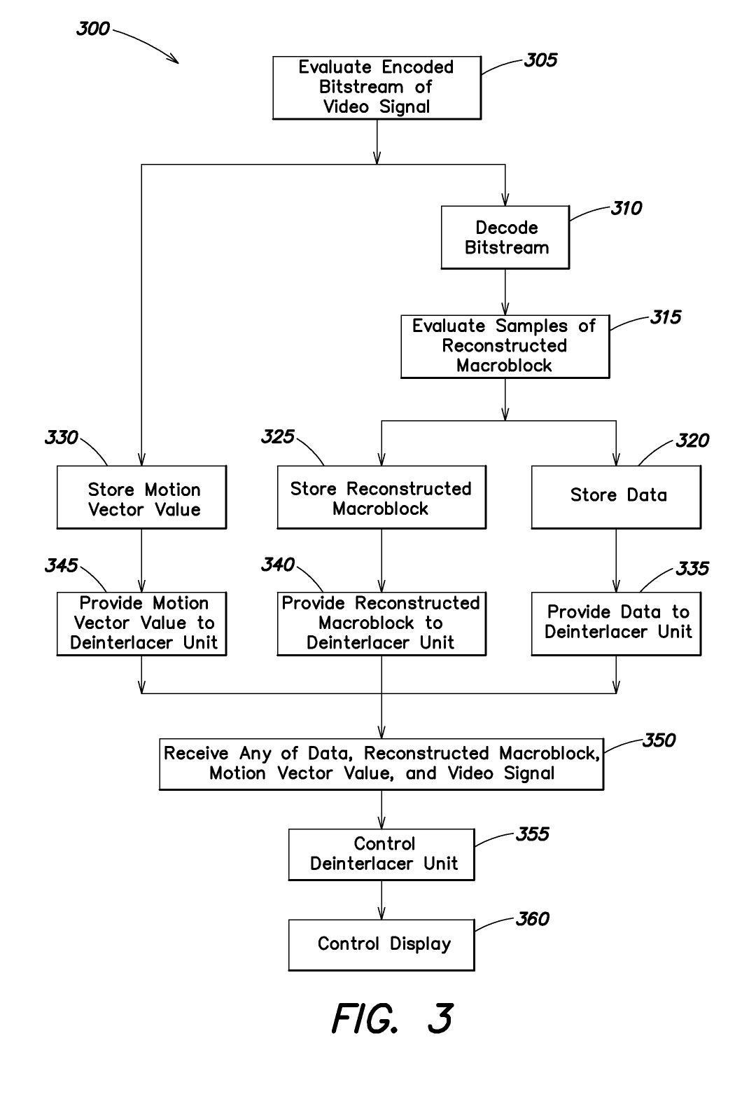

FIG. 3 is a flowchart depicting a method 300 for processing a video signal in accordance with an embodiment of the invention. Method 300 may include an act of evaluating an encoded bitstream of a video signal (ACT 305). In one embodiment, evaluating an encoded bitstream (ACT 305) includes evaluating an encoded bitstream to generate motion vector values corresponding to macroblocks of a video signal. For example, evaluating an encoded bitstream (ACT 305) may include identifying one motion vector value for each macroblock associated with an encoded bitstream.

Method 300 may include the act of decoding at least one video signal, either interlaced or progressive (ACT 310). In one embodiment, decoding a video signal (ACT 310) includes decoding an encoded bitstream of a video signal. For example, decoding a bitstream (ACT 310) may include reconstructing a video signal. In one embodiment, decoding a bitstream (ACT 310) includes generating reconstructed macroblocks of a video signal.

Method 300 may include the act of evaluating a plurality of samples of a reconstructed macroblock (ACT 315). In one embodiment, evaluating reconstructed macroblocks (ACT 315) includes evaluating samples of reconstructed macroblocks of a video signal to generate data, such as component values of pixels associated with at least one of the plurality of samples. For example, evaluating samples of a reconstructed macroblock (ACT 315) may include evaluating the samples of decoder unit output to generate data associating a sample with motion. Evaluating samples of a reconstructed macroblock (ACT 315) may also include generating data identifying a sample as being associated with field motion between, for example, consecutive fields of a frame. Evaluating samples of a reconstructed macroblock (ACT 315) may also include generating data indicating cadence of a video signal, data identifying a field that was added to a video signal, or data identifying edits, such as bad edits, made to a video signal. Evaluating samples of a reconstructed macroblock (ACT 315) may also include generating data identifying at least one sample as being associated with an edge of an image included in the video signal. In one embodiment, evaluating samples of a reconstructed macroblock (ACT 315), includes generating data associated with any sample of the reconstructed macroblock, including data indicative of a magnitude or amount of motion, cadence, edge, or other data.

In at least one embodiment, method 300 includes at least one of an act of storing data (ACT 320), and at least one act of storing reconstructed macroblocks of a video signal (ACT 325). Method 300 may additionally include the act of storing motion vector values (ACT 330). For example, storing data (ACT 320) may include writing data associated with sample motion to a data storage unit or other memory device. In one embodiment, storing data (ACT 320) includes storing data that can be generated by the act of evaluating samples of a reconstructed macroblock of a decoded video signal (ACT 315). For example, storing data (ACT 320) may include storing field motion, sample motion, cadence, edge, or other data associated with samples of a reconstructed macroblock of a video signal. Storing reconstructed macroblocks (ACT 325) may include storing reconstructed macroblocks of a decoded video signal. This may include storing the decoded video signal itself. For example, storing reconstructed macroblocks (ACT 325) may include storing frames of a decoded video signal. These frames, as well as macroblocks included therein, may be written to and read from a data storage unit. In one embodiment, storing reconstructed macroblocks (ACT 325) includes storing reconstructed macroblocks generated by an act of decoding a video signal (ACT 310).

Storing at least one motion vector value (ACT 330) can include storing a motion vector value generated by the act of evaluating an encoded bitstream of the interlaced video signal (ACT 305). In one embodiment, storing data (ACT 320) and storing reconstructed macroblocks (ACT 325), includes storing the data, such as sampled pixel component values and reconstructed macroblocks in a same data storage unit. Alternatively, data such as sampled pixel component values corresponding to individual pixel information, reconstructed macroblocks, and motion vector values that correspond to whole macroblocks and are additional to the sampled pixel component values, may all be written to (and read from) individual or partially shared data storage units. In one embodiment, storing motion vector values (ACT 330) includes storing one motion vector value per macroblock in a data storage unit.

In one embodiment, method 300 includes an act of providing the data to a deinterlacer unit (ACT 335). For example providing the data (ACT 335) may include enabling the data to be read from a data storage unit. Providing data (ACT 335) may also include transmitting the data from any of a detector unit, data storage unit, or controller to a deinterlacer unit. Providing the data to a deinterlacer unit (ACT 335) can include providing sample based data identifying, for example, samples that are or are not associated with motion or edges. For example, providing data (ACT 335) may include providing field motion data between two or more fields of a frame of a decoded video signal. In one embodiment, providing data (ACT 335) includes providing data indicating video signal cadence. Method 300 may further include an act of providing at least one reconstructed macroblock to a deinterlacer unit (ACT 340). For example, providing the reconstructed macroblocks (ACT 340) may include enabling the reconstructed macroblocks to be read from a data storage unit. Providing reconstructed macroblocks (ACT 340) may also include transmitting at least one reconstructed macroblock from any of a detector unit, data storage unit, or controller to a deinterlacer unit. Providing reconstructed macroblocks to a deinterlacer unit (ACT 340) can include providing one or more frames of a video signal. For example, providing reconstructed macroblocks (ACT 340) may include providing a video signal to a deinterlacer unit, including frames of the video signal and reconstructed macroblocks thereof.

In one embodiment, processing a video signal includes an act of providing at least one motion vector value to a deinterlacer unit (ACT 345). For example, providing a motion vector value (ACT 345) may include providing motion vector values generated from video signal bitstream input into a decoder to a deinterlacer unit where each motion vector value indicates a degree of motion associated with one reconstructed macroblock as a whole. Providing a motion vector value (ACT 345) may also include enabling motion vector values, each corresponding to a macroblock, to be read from a data storage unit. In one embodiment, providing motion vector values (ACT 345) includes transmitting at least one motion vector value associated with a macroblock from any of a detector unit, data storage unit, or controller to a deinterlacer unit. In one embodiment, providing a motion vector (ACT 345) includes providing an indication of a macroblock associated with the motion vector.

It should be appreciated that data, such as individual pixel component values generated from samples of the video signal, may be provided to a deinterlacer unit concurrently, sequentially, or independently with reconstructed macroblocks and any additional motion vector values of whole macroblocks of a video signal. Data such as field motion data, reconstructed macroblocks, and additionally any motion vector values may be provided (ACTS 335, 340, and 345) together or separately to, for example, a controller or to a deinterlacer unit. In one embodiment, data includes field motion data based on an evaluations of a sample of individual pixels of a macroblock, and providing that data (ACT 335) includes providing an indication of a macroblock associated with the sample.

Method 300 may include an act of receiving at least one of data, such as sampled pixel information, reconstructed macroblocks, motion vector values, and a video signal (ACT 350). For example receiving any of this information (ACT 350) may include reading at least one of the data, reconstructed macroblocks, motion vector values, and a video signal from a data storage unit or associated buffers. Receiving at least some of this information (ACT 350) may also include receiving information that upon transmission through a communication channel.

Method 300 may also include an act of controlling a deinterlacer unit (ACT 355). For example, controlling a deinterlacer unit may include providing instructions to a deinterlacer unit that cause the deinterlacer unit to perform a particular deinterlacing scheme to generate a video signal for display. There are a variety of deinterlacing schemes. In one embodiment, based on the nature of any data and reconstructed macroblocks that are provided to a deinterlacer unit (ACT 340) one deinterlacing scheme may be advantageous over another deinterlacing scheme. Controlling a deinterlacer unit (ACT 355) may include directing a deinterlacer unit to implement one or more of a plurality of potential deinterlacing schemes, including but not limited to the handling of artifacts associated with either interlaced or progressive video signals. Controlling a deinterlacer unit (ACT 355) may include controlling a deinterlacer unit to deinterlace an interlaced video signal or any frames, fields, or reconstructed macroblocks thereof. Controlling a deinterlacer unit (ACT 355) may also include controlling a deinterlacer unit based at least in part on any data (e.g., cadence, pixel based field motion, or edge) associated with macroblocks as a whole. In one embodiment, controlling a deinterlacer unit (ACT 355) includes providing or transmitting any motion vector values, reconstructed macroblocks and/or data to a deinterlacer unit, where the deinterlacer unit receives and evaluates this information to select an appropriate deinterlacing scheme. In one embodiment, method 300 also includes an act of controlling a display (ACT 360) that displays a video signal received from a deinterlacing unit.

Note that in FIGS. 1 through 3, the enumerated items are shown as individual elements. In actual implementations of the systems and methods described herein, however, they may be inseparable components of other electronic devices such as a digital computer. Thus, actions described above may be implemented in software that may be embodied in an article of manufacture that includes a program storage medium. The program storage medium includes data signals embodied in one or more of a carrier wave, a computer disk (magnetic, or optical (e.g., CD or DVD, or both), non-volatile memory, tape, a system memory, and a computer hard drive.

From the foregoing, it will be appreciated that the systems and methods described herein afford a simple and effective way to process a video signal. These aspects and embodiments can perform sample based evaluation of pixels of reconstructed macroblocks of a video signal at a decoding stage, prior to providing the video signal to a deinterlacer. Samples of reconstructed macroblocks are evaluated to determine motion, cadence, or edge data. This data can be stored in a storage unit, as well as the corresponding reconstructed macroblocks and any motion vector values, and can be provided to a deinterlacer. The deinterlacer or associated logic may evaluate this information to identify and implement a deinterlacing scheme that is best suited to the video signal. This reduces deinterlacer bandwidth requirements, processing power, and other inefficiencies, and enables a deinterlacer unit to generate an output video signal with reduced or eliminated visually perceptible artifacts that may have been encoded into the corresponding input video signal. Any references to front and back, left and right, odd and even, top and bottom, and upper and lower are intended for convenience of description, not to limit the present systems and methods or their components to any one positional or spatial orientation.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements.

Any embodiment disclosed herein may be combined with any other embodiment, and references such as “an embodiment”, “some embodiments”, “an alternate embodiment”, “various embodiments”, or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the objects, aims, and needs disclosed herein. References to “or” may be construed as inclusive so that any terms described using “or” may indicate any of a single, more than one, and all of the described terms.

Where technical features in the drawings, description or any claim are followed by references signs, the reference signs have been included for the sole purpose of increasing the intelligibility of the claims and accordingly, neither the reference signs nor their absence have any limiting effect on the scope of any claim elements.

One skilled in the art will realize the systems and methods described herein may be embodied in other specific forms without departing from the spirit or essential characteristics thereof. For example, a deinterlacer may perform additional motion, edge, or cadence detection operations to determine an appropriate deinterlacing scheme. The foregoing embodiments are therefore to be considered in all respects illustrative rather than limiting of the described systems and methods. Scope of the systems and methods described herein is thus indicated by the appended claims, rather than the foregoing description, and all changes that come within the meaning and range of equivalency of the claims are therefore intended to be embraced therein.

What is claimed is:

1. A method for processing a video signal, comprising:
evaluating a plurality of samples of a reconstructed macroblock of a decoded portion of the video signal;
generating data associated with at least one of the plurality of samples responsive to the evaluation the plurality of samples;
storing the data associated with at least one of the plurality of samples in a data storage unit;
providing the stored data and the reconstructed macroblock to a deinterlacer unit; and
controlling the deinterlacer unit to deinterlace the reconstructed macroblock based at least in part on the stored data.

2. The method of claim 1, comprising:
evaluating an encoded bitstream of the video signal to identify a motion vector value associated with a macroblock of the encoded bitstream;
storing the motion vector value in the data storage unit;
providing the motion vector value to the deinterlacer unit; and
controlling the deinterlacer unit to deinterlace the video signal based at least in part on the motion vector value.

3. The method of claim 1, comprising:
decoding a bitstream of the video signal to generate the reconstructed macroblock.

4. The method of claim 1, wherein evaluating the plurality of samples comprises detecting cadence of the video signal, and wherein providing the stored data and the reconstructed macroblock to the deinterlacer unit comprises providing information related to the cadence of the video signal to the deinterlacer unit.

5. The method of claim 1, wherein evaluating the plurality of samples comprises detecting a sample associated with an edge of an image of the video signal, wherein the stored data includes information identifying the sample as being associated with the edge.

6. The method of claim 1, wherein controlling the deinterlacer unit comprises controlling the deinterlacer unit to remove at least one artifact from the video signal based at least in part on the stored data.

7. The method of claim 1, wherein evaluating the plurality of samples comprises detecting a sample associated with motion, and wherein providing the stored data and the reconstructed macroblock to the deinterlacer unit comprises providing information identifying the sample as being associated with motion.

8. The method of claim 1, wherein evaluating the plurality of samples comprises:
detecting field motion between consecutive fields of a frame of the video signal.

9. The method of claim 1, wherein evaluating the plurality of samples comprises:
evaluating at least one of the plurality of samples of the reconstructed macroblock to detect an edge of an image of the video signal;
generating edge data identifying at least one of the plurality of samples as a sample associated with the edge; and wherein the stored data includes the edge data.

10. The method of claim 1, comprising:
receiving the stored data and the video signal including the reconstructed macroblock at the deinterlacer unit.

11. The method of claim 1, wherein evaluating the plurality of samples, generating data associated with at least one of the plurality of samples, storing the data, providing the stored data and the reconstructed macroblock to the deinterlacer unit, and controlling the deinterlacer unit are performed at least in part by a processor, and wherein the method is implemented in a program stored in a computer readable medium and executed at least in part by the processor.

12. A system for processing a video signal, comprising:
a detector unit that operates on a reconstructed macroblock of a decoded portion of the video signal, the detector unit configured to evaluate a plurality of samples of the reconstructed macroblock to generate data associated with at least one of the plurality of samples;
a data storage unit associated with the detector unit and configured to store the data;
a controller configured to provide instructions based on the stored data and the reconstructed macroblock to a deinterlacer unit; and
the deinterlacer unit configured to deinterlace the video signal based at least in part on the stored data and the instructions.

13. The system of claim 12, wherein the detector unit is further configured to evaluate an encoded bitstream of the video signal to identify a motion vector value associated with a macroblock of the encoded bitstream; wherein
the controller is further configured to provide the motion vector value to the deinterlacer unit; and wherein
the deinterlacer unit is further configured to deinterlace the video signal based at least in part on the motion vector value.

14. The system of claim 13, wherein the data storage unit is configured to store the motion vector value.

15. The system of claim 12, further comprising:
a decoder unit coupled to the detector unit and the data storage unit, the decoder unit configured to decode the video signal to generate the reconstructed macroblock.

16. The system of claim 12, wherein the plurality of samples form at least part of a plurality of field lines in a plurality of frames of the video signal, wherein the detector unit includes a motion detector unit that evaluates the plurality of samples;
the motion detector unit configured to generate field motion data that identifies motion between fields of a frame of the video signal;
the controller configured to evaluate the field motion data to determine a frame rate; and
wherein the stored data associated with at least one of the plurality of pixels includes data indicative of the frame rate.

17. The system of claim 16, wherein the controller is configured to evaluate the field motion data to identify an added field of the video signal, and wherein the controller is further configured to provide a location of the added field to the deinterlacer unit.

18. The system of claim 17, wherein the stored data includes the location of the added field.

19. The system of claim 12, wherein the detector unit includes a motion detector unit configured to determine motion and generate motion data that identifies at least one of the plurality of samples as a sample associated with motion in the video signal; and
wherein the stored data associated with at least one of the plurality of samples includes the motion data.

20. The system of claim 12, further comprising:
the detector unit including an edge detector unit that evaluates the plurality of samples to identify an edge of an image of the video signal, the edge detector unit configured to generate edge data that identifies at least one of the plurality of samples as a sample associated with the edge; and
wherein the data associated with at least one of the plurality of samples includes the edge data.

21. The system of claim 20, wherein the edge data includes an edge data bit that identifies the sample associated with the edge.

22. The system of claim 21, wherein the deinterlacer unit produces an output video signal based at least in part on the reconstructed macroblock and the edge data bit.

23. The system of claim 12, wherein the reconstructed macroblock includes a frame having a plurality of fields, and wherein the data identifies field motion between at least two of the plurality of fields.

24. A computer readable medium having stored thereon sequences of instructions including instructions that will cause a processor to:
receive a decoded video signal including a reconstructed macroblock;
evaluate a plurality of samples of the reconstructed macroblock to generate data associated with motion of at least one of the plurality of samples;
store the data associated with motion of at least one of the plurality of samples in a data storage unit;
provide the stored data and the reconstructed macroblock to a deinterlacer unit; and
control the deinterlacer unit to deinterlace the reconstructed macroblock based at least in part on the stored data.

25. A system for processing a video signal corresponding to an image, comprising:
a detector unit that receives a reconstructed macroblock of the video signal;
means for evaluating a plurality of samples of the reconstructed macroblock to generate data associated with at least one of the plurality of samples;
a data storage unit to store the generated data associated with at least one of the plurality of samples;
a controller configured to provide the stored data and the reconstructed macroblock; and
a deinterlacer unit configured to deinterlace the video signal based at least in part on the stored data.

26. The system of claim 25, wherein the video signal is one of: an interlaced video signal and a progressive video signal.
